(19) United States
(12) Patent Application Publication
(10) Pub. No.: US 2013/0161202 A1
(43) Pub. Date: Jun. 27, 2013

(54) ARRANGEMENT AND METHOD FOR POOL SAFETY AND CLEANING AN ELECTROLYTIC CELL

(71) Applicant: Alexander Babych, Slacks Creek (AU)

(72) Inventor: Alexander Babych, Slacks Creek (AU)

(21) Appl. No.: 13/518,864

(22) PCT Filed: Dec. 24, 2010
(86) PCT No.: PCT/AU10/01751

§ 371 Date: Aug. 24, 2012

(30) Foreign Application Priority Data
Dec. 24, 2009 (AU) 2009906302

(51) Int. Cl. C02F 1/461

(52) U.S. Cl. CPC C02F 1/461
USPC 205/755; 204/277; 205/742; 204/240

(57) ABSTRACT

An arrangement for treating water, particularly in swimming pools, with an electrolytic cell and a gas inlet port and fluid communication with a chamber of the cell wherein the gas inlet port allows gas into the chamber to displace water and water flow through the chamber ceases. Additionally, a method for improving safety of a water treatment system the method may include the step of purging water from an electrolytic cell of the water treatment system when water flow through a chamber of the electrolyte cell ceases. Additionally, a method of cleaning electrolytic plates in an electrolytic cell in an arrangement for treating water may include introducing gas into a chamber housing the electrolytic plates, displacing water from around the electrolytic plates with the gas, allowing the electrolytic plates to dry, at least partially, and activating a pump to deliver pressurized water to the chamber.

### FIELD OF THE INVENTION

The present invention relates to an arrangement and method for use in systems for treating bodies of water. More specifically the invention relates to such systems which use electrolytic cells for producing chlorine. The invention is particularly useful in relation to swimming pools and spas but is not limited to such applications.

### BACKGROUND TO THE INVENTION

In order to maintain a swimming pool in a hygienic condition, the water must be filtered and sanitized. Water chlorination is a well known method of removing bacteria and viruses, and the usage of chlorine generation devices within a pool filtration system has become common. Typically, relatively small quantities of salt in the form of sodium chloride (NaCl) are added to the pool water, which is circulated through a pool filtration system. Leaves, dirt and other particulates are removed via a filter screen and the pool water passes into a chlorine generation device, or pool electrolytic cell.

A popular pool chlorinator uses an electrolytic cell. The electrolytic cell usually consists of a number of metal plates, some of which function as a cathode and some function as an anode. The plates are held in a parallel relationship, and tend to be plated with a rare earth metal catalytic coating.

The electrolytic cell passes a current through the salt solution to produce hypochlorite ions (CIO) through the interaction of chlorine and water. These chemicals act as sanitisation agents.

During operation a salt water chlorinator produces hydrogen gas, at a rate of around 0.03 grams of hydrogen gas per gram of chlorine. When water is flowing through the cell, the minute quantities of hydrogen produced are removed, and released to the atmosphere from the pool surface. When water is not flowing (pump is not running for some reason), the hydrogen gas can replace water, building up in the pipes and lead to an explosion risk. Depending on system configuration, hydrogen can fill up a part of the plumbing or even the whole system. This risk is increased because the electrodes are water cooled so that when operated without flowing water the chlorinator might create a pocket of hydrogen in contact with the hot electrodes which in turn can ignite the gas.

Consequences of such explosion could be very tragic. For the purpose of preventing gas build up in significant volumes current systems use so-called hydrogen trap configurations. These configurations rely on gas displacing water in the chlorinator cavity exposing plates to air and stopping current flowing. However this does not completely guarantee safety. There are known accidents of explosion when minor water flow occurs. In current systems there are also water probes used which stop operation of the cell if an absence of water is detected. They also do not completely guarantee safety due to oxidation and build up of calcium scale which may. impede their operation.

After a period of usage, metal plates of the electrolytic cell tend to become covered with a build up of scale. The progressive build-up of this scale adversely affects the electrical efficiency of the electrolytic cell. One method of removing the built up scale is to remove the electrolytic plates from the electrolytic cell and wash them in a weak hydrochloric acid solution which dissolves the scale. However, this is a labour intensive, time consuming task and creates some risk to a user who must handle acid.

Another method requires operation of the electrolytic cell whilst reversing the polarity of the electrolytic plates for a period of time to redissolve the scale. However, it has been observed that the service life of the electrolytic cell in systems using reverse polarity cleaning can sometimes be less than for systems using other cleaning methods.

### OBJECT OF THE INVENTION

It is an object of the invention to overcome or at least alleviate one or more of the above problems and/or provide the consumer with a useful or commercial choice.

### DISCLOSURE OF THE INVENTION

In one form, although it need not be the only or indeed the broadest form, the invention resides in an arrangement for treating water, the arrangement comprising:

an electrolytic cell including a housing defining a chamber and having an inlet and an outlet, the inlet allowing water to enter the chamber and the outlet allowing water to exit the chamber, the electrolytic cell further comprising at least one anode and at least one cathode, each located within the chamber; and

a gas inlet port in fluid communication with the chamber;

wherein:

the gas inlet port is adapted to allow gas into the chamber to displace water when water flow through the chamber ceases.

The gas inlet port is preferably an air inlet port. The expression “water” extends to solutions including those found in swimming pools and spas.

The gas inlet port may be located in the housing. Preferably the gas inlet port is located remote to the electrolytic cell and may be positioned in a water treatment system which includes the arrangement for treating water. The gas inlet port may be located on a water pipe forming part of the water treatment system, and in fluid communication with the electrolytic cell such that gas introduced through the gas inlet port will displace water in the chamber.

The gas inlet port preferably comprises a non-return valve to allow air into the system when pressure drops significantly due to decreased water flow and prevents water loss in normal flow of water in the water treatment system. The non-return valve preferably may be activated when water pressure drops below atmospheric pressure sufficiently to overcome any internal resistance to opening in the valve and allow air to enter the system.

Preferably all the water is displaced from the chamber by the gas.

In an alternative embodiment, the gas inlet port may be in fluid connection with a gas delivery system comprising a source of pressurized gas adapted to introduce the pressurized gas into the system when the pump is stopped or water flow is otherwise arrested or significantly decreased.

Preferably the gas is a non flammable gas such as carbon dioxide or an inert gas such as a nitrogen.

The arrangement may further include at least one gas flow regulator and may comprise first and second stage regulations for controlling delivery pressure of gas.

The pressurized source may be a tank of compressed gas or may be a compressor.

The arrangement may include a timer to regulate the period of gas discharge. The timer may activate a switch such as a solenoid suitable to open and close a gaseous flow path for delivering gas to the system.

Alternatively, gas may be delivered at or around ambient pressure to balance out and cease gas delivery when the electrolytic cell is empty of water.

Further, alternatively the gas may be delivered in a preselected volume to purge the electrolytic cell at least, of water.

The gas may be delivered through a one way valve as described above.

The invention extends to a water treatment system comprising:

a body of water;

an outlet pipe from the body of water;

a pump connected to the outlet pipe;

a filter in fluid communication with the pump;

an electrolytic cell including a housing defining a chamber and having an inlet and an outlet, the inlet allowing water to enter the chamber and the outlet allowing the water to exit the chamber, the electrolytic cell further comprising at least one anode and at least one cathode, each located within the chamber, the electrolytic cell in fluid communication with the filter;

a gas, preferably air;

inlet port in fluid communication with the chamber; and

an inlet pipe in fluid communication with the electrolytic cell and configured to return treated water to the body of water;

wherein:

the gas inlet port is adapted to allow gas, preferably air, into the chamber to displace water when water flow through the chamber ceases.

The body of water is preferably in a swimming pool or spa.

The gas inlet port may be positioned in the housing or preferably positioned remotely from the housing. The gas inlet port preferably comprises a non-return valve to allow air into the system when pressure drops significantly due to decreased water flow and prevents water loss in normal flow of water in the system.

The gas inlet port may be located in the inlet pipe.

In another aspect the invention may reside in a method for improving safety of a water treatment system, preferably a pool circulation system, the method including the step of purging water from an electrolytic cell in the water treatment system when water flow ceases. Purging water from the electrolytic cell preferably comprises displacing water from a chamber of the electrolytic cell in which at least one each of an anode and a cathode are positioned. It is most preferable that the at least one each of an anode and cathode are removed from contact with water. The method preferably includes the step of opening a gas, preferably air, inlet port to the atmosphere such that air can replace water inside the electrolytic cell. This may occur according to the principle of connected vessels. The method preferably includes the step of positioning both a chamber of the electrolytic cell and gas, preferably air, inlet port above a level of water in the pool and preferably at or around a highest point of the circulation system.

In another form the invention may lie in a method of cleaning electrode plates in an electrolytic cell in a water treatment system, the method comprising the steps of:

introducing gas, preferably air into a chamber housing the electrode plates;

displacing water from around the electrode plates with the gas;

allowing the electrode plates to dry, at least partially; and activating a pump to deliver pressurized water to the chamber.

Introducing gas into a chamber housing the electrode plates may include the steps described above. The arrangement described above may also be used for cleaning electrode plates.

Activating a pump to deliver pressurized water to the chamber may provide a small hydroblow assisting with separation of calcium from the plates, particularly after drying.

Further features of the present invention will become apparent from the following detailed description.

### BRIEF DESCRIPTION OF THE DRAWINGS

To assist, in understanding the invention and to enable a person skilled in the art to put the invention into practical effect preferred embodiments of the invention will be described by way of example only with reference to the accompanying drawings, wherein:

FIG. 1 shows a schematic water treatment system with an arrangement of the present invention and with pump switched on and water circulating through the system; and

FIG. 2 shows the schematic water treatment system of FIG. 1 with pump switched off and plates exposed to air.

FIG. 3 is a schematic representation of a pool system with an arrangement of the present invention including a gas delivery system.

### DETAILED DESCRIPTION OF THE INVENTION

To assist with the understanding of this invention, a number of specific embodiments will be described with particular reference to an electrolytic cell.

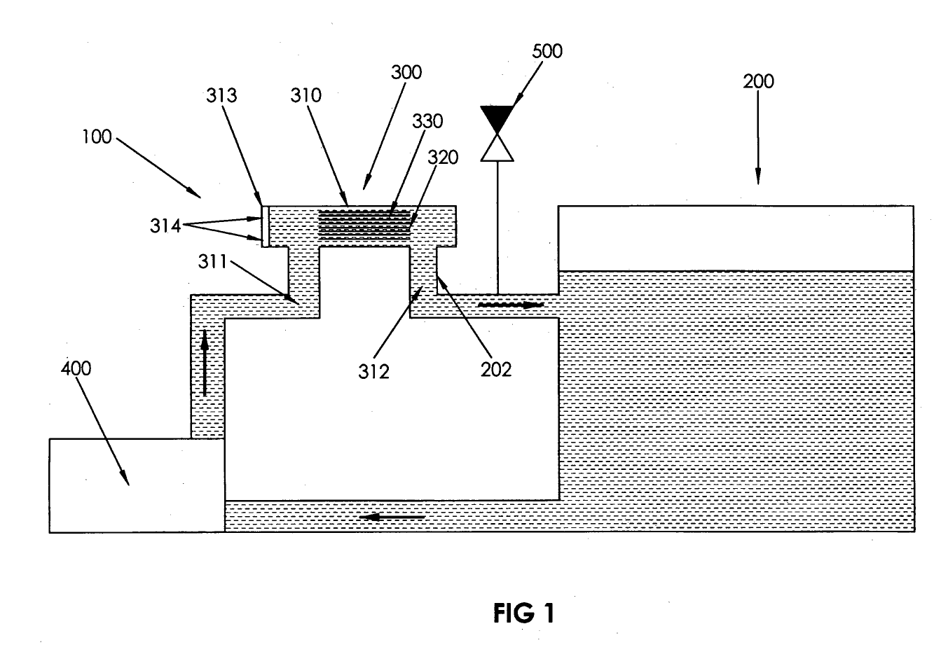

An embodiment of a water treatment system as exemplified by pool circulation system 100 is shown in FIG. 1. The pool circulation system 100 includes a pool 200, an electrolytic cell 300, a pump 400 and a valve 500 (preferably non-return). The electrolytic cell 300 and valve 500 are in fluid communication via inlet pipe 202 and form one example of an arrangement for treating water of the present invention. Chlorinator 300 has a housing 310 with an inlet 311 and an outlet 312. The diameter of the inlet 31 and the outlet 312 are typically of the same size. A removable end cap 313 is fitted to an end of the housing 310. Two electrode holes 314 extend through end cap 313.

A series of anodes 320 and cathodes 330 are located within a chamber 340 of the housing. The anodes 320 are electrically connected to each other via an anode busbar (not shown). The anodes 320 may be either solid metal or manufactured from a mesh. The anode busbar is connected to an electrode bolt (not shown), which extends through one of the electrode holes 314 of the end cap 313. The electrode bolt is used to electrically charge the anodes 320.

The cathodes 330 are manufactured from a flat solid metal, and are electrically connected to each other via a cathode busbar (not shown). The cathode busbar is connected to an electrode bolt (not shown) which extends through one of the electrode holes 314 of the end cap 313. The electrode bolt is used to electrically charge the cathodes 330.

The pump 400 is in fluid connection with the electrolytic cell 300 and pumps aqueous solution, i.e. pool water, from a source to the electrolytic cell 300. The inlet 311 of the housing 310 is fluidly connected to the pump 400 to allow aqueous solution to be pumped into the chamber 340 of housing 310 which is subsequently expelled out of the outlet 312. A suitable type of pump for this application is well known in the field.

Pump 400 creates pressure which holds non-return valve 500 closed and water circulates through the pool system as shown on FIG. 1. A nonreturn valve is also known as a check valve or one-way valve and is adapted to allow fluid (liquid or gas) to flow through in one direction. Such valves are well known in the art. While a non-return valve is preferred, a skilled addressee may use other arrangements that are functional.

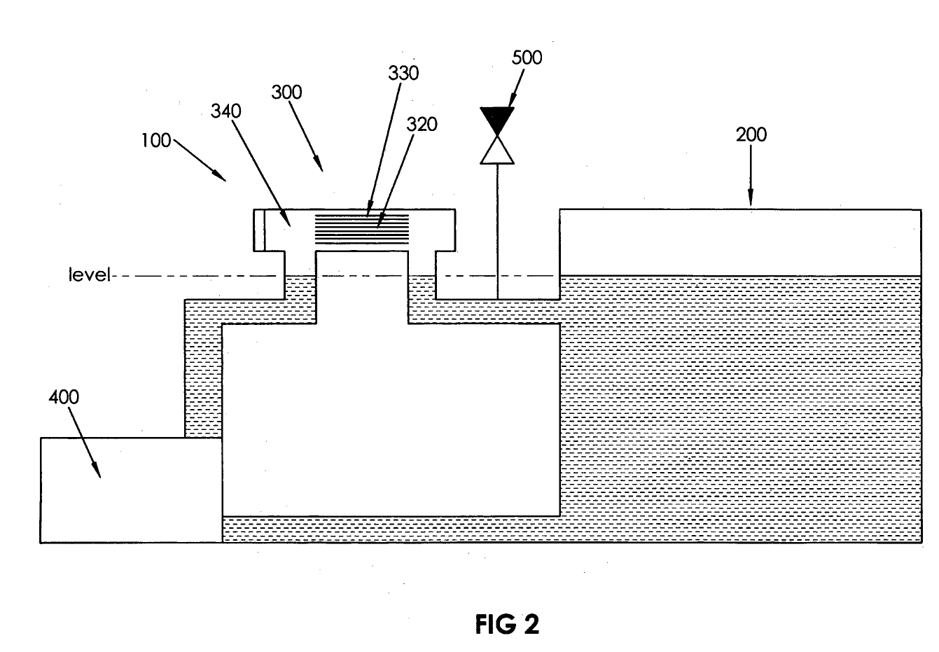

Once pump 400 is switched off (by power pack or any other reason) water flow ceases and pressure drops immediately (see FIG. 2). It should be understood that “cease” may extend to water flow being compromised. If water pressure drops enough it allows atmospheric pressure to open nonreturn valve 500 and evens the water level in plumbing external to the pool with a water level of the pool. The explanation for this may be based on the law of communicated vessels. Water purges from chlorinator plates 320, 330. Once plates 320, 330 are dry there is no electrical current and therefore no hydrogen generated. This provides a safety system which prevents accumulation of hydrogen and prevents any risk of explosion.

When the chlorinator plates or electrodes are exposed to air, they tend to dry which results in simultaneous drying of calcium deposits. When the pump 400 restarts it creates hydroblow or a pulse of water which helps to separate calcium from chlorinator plates providing a cleaning advantage. The displaced plaque is redistributed to the pool and may be picked up by bottom cleaning vacuum devices. It is then filtered out of the system.

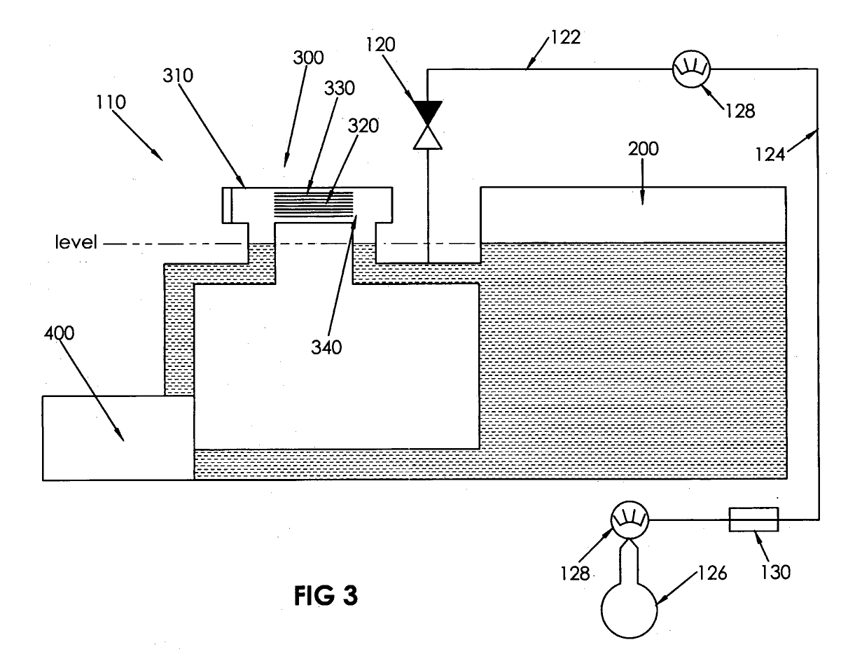

Referring to FIG. 3, there is seen an embodiment of a water treatment system 110 incorporating gas inlet port 120 in fluid connection with delivery lines 124, 123. A source of pressurized gas in container 126 is connected to delivery line 124 via first stage regulator 128 which reduces pressure form the container 26 delivery is to the second stage regulator 128 which allows for manipulation of the final pressure.

In this system the gas pressure may be set to on around ambient pressure to empty the housing 310 when the pump stops.

It is preferred an electronic controller 130 is provided to control delivery of the gas. The controller may release gas to the delivery lines for a set period, sufficient to empty the housing 310 and its chamber 340 of water. Alternatively the controller may release a preselected volume of gas to empty the housing 310 and chamber 34 of water. The type and components of such a controller are known to a person skilled in the art.

The preferred gas is a non combustible gas such as carbon chloride, nitrogen or other suitable gas. It may be air.

The present invention is therefore multi-factorial in its operation. It creates an important safety level for circulation systems of swimming pools (spas, and similar water bodies.) and significantly decreases the risk of hydrogen accumulation and explosion. Any existing system with suitable configuration can be modified using the described arrangement. The major preferred requirement is that plates of the electrolytic cell and the valve are installed above the water level of the pool.

This cleaning method decreases the need for the operator of a pool to take action to maintain the electrolytic cells. The invention reduces the use of chemical agents which could contaminate the pool water or upset the delicate pH balance required for hygienic operation of a pool.

The life of the cathode and anode plates of the electrolytic cell is expected to be longer than those of electrolytic cells cleaned by reverse polarity methods, although it should be noted that the arrangement works also on reverse polarity systems. As polarity reversal is not required, the plates are not damaged during a cleaning cycle.

Throughout the specification the aim has been to describe the invention without limiting the invention to any one embodiment or specific collection of features. Persons skilled in the relevant art may realize variations from the specific embodiments that will nonetheless fall within the scope of the invention. For example, the non-return valve 500 may be any valve controlled by any type of control devices.

It will be appreciated that various other changes and modifications may be made to the embodiment described without departing from the spirit and scope of the invention.

1. An arrangement for treating water, the arrangement comprising:
an electrolytic cell including a housing defining a chamber, an inlet allowing water solution to enter the chamber and an outlet allowing water solution to exit the chamber, the electrolytic cell further comprising at least one each of an anode and a cathode, each located in the chamber; and
a gas inlet port in fluid communication with the chamber; wherein
the gas inlet water is adapted to allow gas into the chamber to displace water when water flow through the chamber ceases.

2. The arrangement for treating water of claim 1 wherein the gas inlet port is located in the housing.

3. The arrangement for treating water of claim 1, wherein the gas inlet port is located remote from the electrolytic cell in a water pipe forming part of a water treatment system and in fluid communication with electrolytic cell.

4. The arrangement for treating water of any one of the preceding claims wherein the gas inlet port is a non-return valve adapted to allow gas or air into the system when water pressure in the water treatment system, drops significantly due to decreased water flow in the water treatment system.

5. The arrangement for treating water of claim 4 wherein the non-return valve is activated when water pressure in the water treatment system drops below atmospheric pressure sufficiently to overcome internal resistance to opening of the valve.

6. The arrangement for treating water of claim 1 wherein all water is displaced from the chamber by the gas.

7. The arrangement for treating water of claim 1 wherein the gas inlet port is in fluid communication with a gas delivery system comprising a source of pressurized gas for introducing the gas into the system when water flow through the chamber center.

8. The arrangement for treating water of claim 7 wherein the gas is a non-flammable gas such as carbon dioxide or an inert gas such as nitrogen.

9. The arrangement for treating water of claim 7 further including at least one gas flow regulator for controlling delivery pressure of gas.

10. The arrangement for treating water of claim 7 wherein the pressurized source is a tank of compressed gas or a compressor.

11. The arrangement for treating water of claim 7 further including a timer to regulate the period of gaseous discharge, the timer adapted to open and close a gaseous flow path delivering gas to the chamber.

12. The arrangement for treating water of claim 7 wherein gas is introduced at or around ambient pressure.

13. The arrangement for treating water of claim 7 wherein the gas is delivered in a pre-selected volume to purge the chamber of water.

14. A method for improving safety of a water treatment system the method including the step of purging water from an electrolytic cell of the water treatment system when water flow through a chamber of the electrolyte cell ceases.

15. The method of claim 14 wherein purging water from the electrolytic cell comprises displacing water from a chamber of the electrolytic cell to remove all anodes and cathodes from contact with water.

16. The method of claim 14 further including the step of opening an air inlet port to the atmosphere to allow air to replace water inside the electrolytic cell.

17. The method of claim 14 further including the step of positioning both the chamber of both the electrolytic cell and an air inlet port above a level of water in a pool and at or around the highest point of the water treatment system.

18. A method of cleaning electrolytic plates in an electrolytic cell in an arrangement for treating water, the method comprising the steps of:
introducing gas into a chamber housing the electrolytic plates;
displacing water from around the electrolytic plates with the gas;
allowing the electrolytic plates to dry, at least partially; and
activating a pump to deliver pressurized water to the chamber.

19. A water treatment system comprising;
a body of water;
an outlet pipe for the body of water;
a pump connected to the outlet pipe;
a filter in fluid communication with the pump;
an electrolytic cell including a housing defining a chamber and having an inlet and an outlet, the inlet allowing water to enter the chamber and the outlet allowing water to exit the chamber, the electrolytic cell further comprising at least one anode and at least one cathode, each located within the chamber, the electrolytic cell and fluid communication with the filter;
a gas inlet port in fluid communication with the chamber; and an inlet pipe in fluid communication with the electrolytic cell and figured to return treated water to the body of water; wherein; the gas inlet port is adapted to allow gas into the chamber to displace water when flow through the chamber ceases.

20. A water treatment system as claimed in claim 19 wherein the body of water is a swimming pool or spa.
